(19) United States
(12) Patent Application Publication
(10) Pub. No.: US 2025/0310642 A1
(43) Pub. Date: Oct. 2, 2025

(54) IMAGE PROCESSING APPARATUS, IMAGING APPARATUS, CONTROL METHOD, AND STORAGE MEDIUM THEREOF

(71) Applicant: CANON KABUSHIKI KAISHA, Tokyo (JP)

(72) Inventor: SHOHEI KATSUYA, Kanagawa (JP)

(21) Appl. No.: 19/078,065

(22) Filed: Mar. 12, 2025

(30) Foreign Application Priority Data
Mar. 27, 2024 (JP) 2024-052293

(51) Int. Cl. H04N 23/67; H04N 23/611; H04N 23/62

(52) U.S. Cl. CPC H04N 23/675; H04N 23/611; H04N 23/62

(57) ABSTRACT

An image processing apparatus that can detect a subject of high interest to a user from among a number of subjects in a captured image and select the subject as a main subject includes one or more processors and at least one memory, in communication with the one or more processors, storing a program, which when executed by the one or more processors, cause the image processing apparatus to detect a plurality of subjects from a captured image, determine a candidate area for determining a main subject from the captured image, and determine the main subject from among the detected plurality of subjects within the determined candidate area, where the determination of the candidate area is based on a method associated with an imaging setting for capturing the captured image.

### BACKGROUND

### Field

The present disclosure relates to a detection apparatus that detects a subject.

### Description of the Related Art

Conventionally, imaging apparatuses such as digital cameras equipped with a tracking autofocus (AF) mode have been commercialized. The tracking AF mode is a mode in which a subject such as a person, an animal, or a vehicle is detected from images continuously output from an imaging element, and the state of focus on the detected subject is continuously optimized.

If a plurality of subjects is detected, it is necessary to select from among them a subject on which the focus and exposure states are to actually be optimized (hereinafter, also referred to as a main subject).

As a method for selecting a main subject, there has been discussed a method by which some kind of evaluation is performed on a plurality of detected subjects, and the main subject is determined based on the result of the evaluation.

Japanese Patent Application Laid-Open No. 2012-156704 discusses a method by which to recognize facial expressions and select main subject candidates based on the degree of smiling. Japanese Patent Application Laid-Open No. 2013-232060 discusses a configuration for performing individual recognition and controlling focus and exposure using information on whether it has been determined that the subject is the same as a previously registered subject.

Evaluating all of a plurality of detected subjects may cause issues in terms of processing speed and power consumption. In recent years, it has become common practice to use deep learning algorithms to improve accuracy in the evaluation of personal recognition and posture estimation. In apparatuses such as digital cameras that have limited resources and use embedded software, it may be difficult to perform authentication processing with a heavy processing load on a large number of subjects, within the limited resources.

If there are a large number of subjects, it is desirable to, rather than evaluate each of the subjects, perform a screening of evaluation target subjects and evaluate only a number of subjects that satisfy the requirements for processing speed, power consumption, and the like.

### SUMMARY

The present disclosure is directed to providing an image processing apparatus, an imaging apparatus, and a control method thereof that make enable determining a main subject that matches the user's intention from among a plurality of subjects while achieving a higher processing speed or reduced power consumption.

According to an aspect of the present disclosure, an image processing apparatus includes one or more processors and at least one memory, in communication with the one or more processors, storing a program, which when executed by the one or more processors, cause the image processing apparatus to detect a plurality of subjects from a captured image, determine a candidate area for determining a main subject from the captured image, and determine the main subject from among the detected plurality of subjects within the determined candidate area, wherein the determination of the candidate area is based on a method associated with an imaging setting for capturing the captured image.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a digital single-lens camera as an exemplary embodiment of an imaging apparatus.

FIG. 2 is a block diagram of a control system of the camera.

FIG. 3 is a configuration diagram of a neural network used in the exemplary embodiment.

FIG. 4 is a flowchart illustrating a process of selecting one of a plurality of screening methods.

FIGS. 5A and 5B are diagrams illustrating specific examples of determining a tracking target.

FIG. 6 is a diagram illustrating in-AF area priority screening.

FIG. 7 is a diagram illustrating near-tracking target priority screening.

FIGS. 8A and 8B are diagrams illustrating near-focal plane priority screening.

### DESCRIPTION OF THE EMBODIMENTS

Hereinafter, exemplary embodiments will be described in detail with reference to the accompanying drawings. The following exemplary embodiments are not seen to be limiting. While the exemplary embodiments include a plurality of features, not all of these features are deemed essential, and the features may be combined in any manner. In the accompanying drawings, the same or similar components are given the same reference numbers, and duplicated descriptions thereof are omitted.

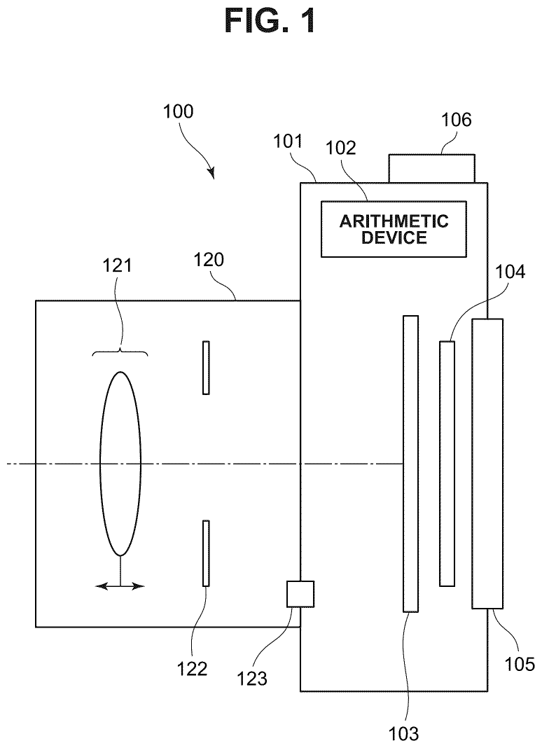

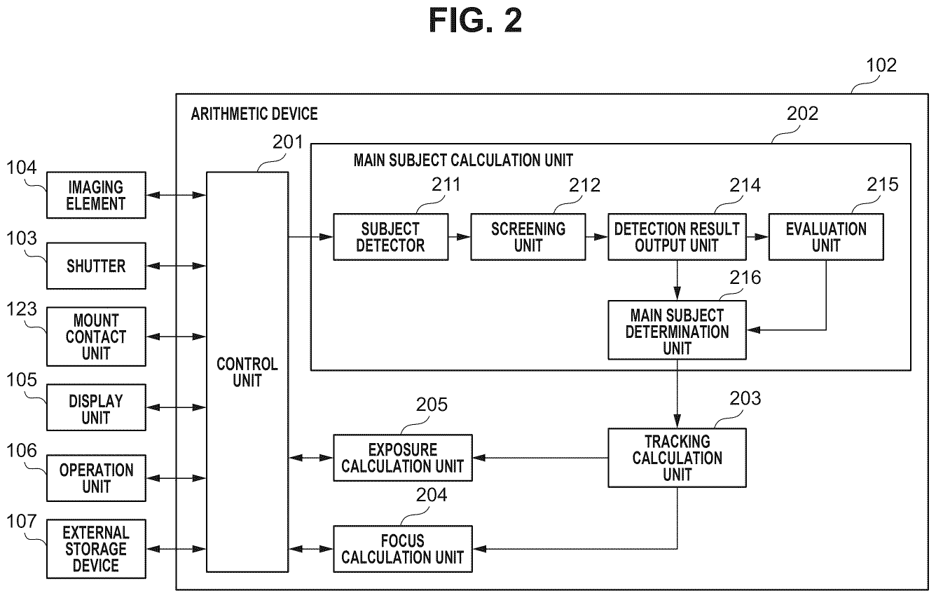

FIG. 1 is a diagram illustrating a configuration of a digital single-lens camera (hereinafter, referred to as a camera) 100 which is an exemplary embodiment of an imaging apparatus of the present disclosure. FIG. 2 is a diagram illustrating a configuration relating to the control of the camera 100. The exemplary embodiment described below is an example in which the present disclosure is applied to an imaging apparatus that can capture images under different shooting conditions from shot images as an example of an image processing apparatus. The present disclosure can be applied to any other device that can generate images under different shooting conditions from shot images.

In the camera 100 of the present exemplary embodiment, as illustrated in FIG. 1, a detachable and interchangeable lens unit 120 is attached to the front side (subject side) of a camera body 101. The lens unit 120 has a focus lens 121, an aperture 122, and the like, and is electrically connected to the camera body 101 via a mount contact unit 123. A control unit 201 (see FIG. 2) of the camera body 101 can, via the electrical connection, control the lens unit 120 to adjust the amount of light entering the camera body 101 and the focal position. The focus lens 121 can also be manually adjusted (manual focus) by the user.

An imaging element 104 that captures a subject image includes a charge-coupled device (CCD) or complementary metal oxide semiconductor (CMOS) sensor, or the like, and includes an infrared cut filter, a low-pass filter, and the like. The imaging element 104 receives a light beam from the subject via an imaging optical system including the lens unit 120, photoelectrically converts the subject image formed on the imaging surface, and transmits signal information for generating a captured image to an arithmetic device 102. The arithmetic device 102 generates a captured image from the received signal information, stores the captured image in an external storage device 107 (see FIG. 2), and displays the captured image on a display unit 105 such as a liquid crystal display (LCD). A shutter 103 shields the imaging element 104 from light when not capturing an image, and opens to expose the imaging element 104 when capturing an image.

Next, a configuration relating to the control of the camera 100 will be described with reference to FIG. 2.

The arithmetic device 102 includes a multi-core central processing unit (CPU) that can process a plurality of tasks in parallel, a random access memory (RAM), and a read only memory (ROM), a dedicated circuit for executing specific arithmetic processing at high speed, and the like. The arithmetic device 102 includes the control unit 201, a main subject calculation unit 202 for detecting a subject, a tracking calculation unit 203, a focus calculation unit 204, an exposure calculation unit 205, and the like. The control unit 201 controls each part of the camera body 101 and the lens unit 120.

One or more of the functional blocks illustrated in FIG. 2 may be implemented by hardware such as an application specific integrated circuit (ASIC) or a programmable logic array (PLA), or may be implemented by a programmable processor such as a CPU or micro processing unit (MPU) executing software. The functional blocks may also be implemented by a combination of software and hardware. In the following description, even if operations are described as being performed by different functional blocks, they may be implemented by the same unit of hardware.

An operation unit 106 has a plurality of input devices (buttons, switches, dials, and the like) that can be operated by the user. Some of the input devices of the operation unit 106 are named in correspondence with the functions assigned to them. For examples, the operation unit 106 includes a shutter button, a mode change switch, a power switch, and the like. If the display unit 105 is a touch display, the operation unit 106 also includes the touch panel. The control unit 201 monitors the operations of the input devices included in the operation unit 106. Upon detection of an operation of an input device, the control unit 201 executes a process corresponding to the detected operation.

The shutter button has a first shutter switch (SW1) that is turned on when pressed halfway, and a second shutter switch (SW2) that is turned on when pressed all the way. Upon detection of turn-on of the SW1, the control unit 201 executes preparatory operations for still image shooting. The preparatory operations include auto exposure (AE) processing and auto focus (AF) processing. Upon detection of turn-on of the SW2, the control unit 201 executes still image shooting and recording operation based on the shooting conditions determined by the AE processing.

The mode change switch is an operation unit for switching from among various shooting modes, a playback mode, and the like. The method for mode switching is not limited to operating the switch.

The main subject calculation unit 202 includes a subject detector 211 that detects subjects, a screening unit 212 that selects all or some of the subjects detected by subject detector 211, and a detection result output unit 214 that outputs the detection results of the subjects selected by the screening unit 212. The main subject calculation unit 202 also includes an evaluation unit 215 that evaluates each of the subjects output by the detection result output unit 214, and a main subject determination unit 216 that determines a main subject based on the output subjects and the results of evaluation by the evaluation unit 215.

The subject detector 211 sequentially receives successive images acquired from the imaging element 104 and performs processing on the images to detect subjects such as people, animals, and vehicles from each image. As a detection method, any known method such as AdaBoost or a convolutional neural network (CNN) can be used. In addition, the form of implementation may be a program running on a CPU, dedicated hardware, or a combination of these.

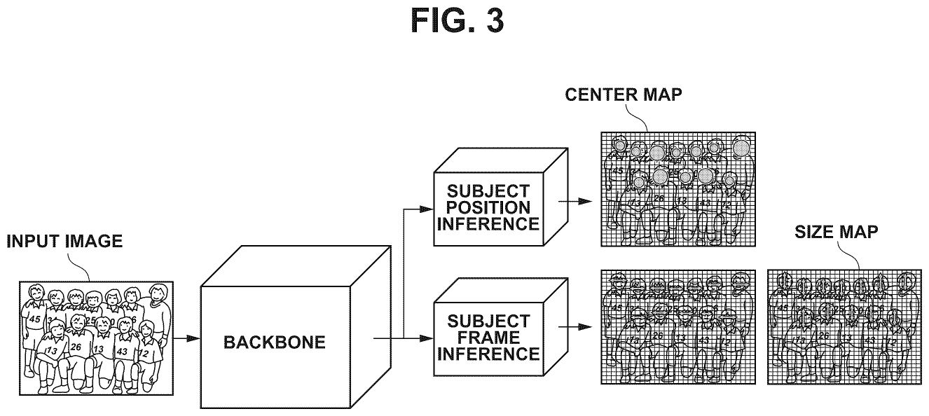

FIG. 3 illustrates a configuration of a neural network used in the present exemplary embodiment. In this network, when an image is input to a network called backbone, intermediate features are output. The features obtained through the backbone are input to networks separated by the tasks of estimating the position of a subject (such as a vehicle or an animal) and the subject frame.

In the network illustrated in FIG. 3, obtained are a “center map” that indicates the center positions of subjects, and two “size maps” that indicate the widths and heights of frames surrounding the subjects (subject frames). Each map is a two-dimensional array and is represented by a grid. In the center map, the likelihoods of the center positions of the subjects are inferred in the array.

The center map indicates that the closer to the center of a black circle, the higher the likelihood of the corresponding subject. The size maps are two maps, one for width and one for height, in which the width and height of each subject are inferred with reference to the assumed center position of the subject. The size maps represent the magnitude of each value with the length of a double arrow, where the values indicating the width and height are inferred at the center position of each subject.

The subject detector 211 can switch from among different networks based on the type of subject to be detected. For example, the networks may be classified into categories such as people, animals, and vehicles, or in more detail, may be classified into categories such as human faces, human heads, and human upper bodies. The subject detector 211 selects some or all of these models in each input image to perform object detection processing. The network configuration may be changed for each type of subject, or the backbone may be standardized and the latter stages may be separate networks. The network of the same configuration may be used to obtain parameters (weights) with different learning data for each type of subject.

The screening unit 212 receives the center map and the size maps from the subject detector 211, and selects (determines) a predetermined number of subject areas (center coordinates, width, and height) for each model. A specific screening method will be described below.

The screening unit 212 also integrates the results of inference by a plurality of models. That is, the screening unit 212 selects a predetermined number of subject areas after analysis of correlation from among the plurality of subject areas selected in a plurality of networks. For example, if a detection process is performed on an input image using a human face network and a human head network, subject areas for the same subject may be output from both networks. To suppress such redundancy, if the intersection over union (IoU) of subject areas inferred by a plurality of models is greater than or equal to a predetermined threshold, the screening unit 212 determines that the subject areas belong to the same subject. In this case, the inference result of one model is ignored, or the inference results of both models is averaged. In a model that is assumed to infer different parts of the same subject, the model learns that the parts belong to the same subject. In the present exemplary embodiment, these processes based on IoU are called correlation analysis (connection). After the end of correlation analysis, the screening unit 212 selects a predetermined number of subject areas from all subject areas remaining as subject detection results.

The screening method here can be the same as the screening method for each model. The specific screening method will be described below.

Upon completion of the screening, the detection result output unit 214 outputs a predetermined number of subject areas that are the detection results as candidate areas for the main subject. Examples of the output method include outputting to a storage medium such as a volatile memory in the arithmetic device 102, and communicating with the CPU via I2C communication or the like. In the present exemplary embodiment, each model outputs the detection result to a predetermined area in the volatile memory.

The evaluation unit 215 performs additional evaluation on each of the subject areas that are the output detection results. Examples of the evaluation include personal recognition for identifying an individual person and posture estimation for estimating the posture of the subject. In the present exemplary embodiment, both personal recognition and posture estimation are performed, but the present disclosure may be configured to perform at least one of them or other evaluations.

In the personal recognition, the facial area of a subject is trimmed, and the trimmed image is input into a recognition model to compare with a previously registered (learned) person for similarity and evaluate whether the person is the subject. The personal recognition is also generally performed using a neural network, and the processing time may be long when a network with high recognition performance is used. If a plurality of subjects is seen in an input image, recognition processing need to be performed on each of the subjects, which may increase processing time along with an increase in the number of persons. As in the present exemplary embodiment, performing a screening of subjects in advance using the screening unit 212 suppresses the processing time from increasing too much.

In the posture estimation, the evaluation unit 215 detects joint points of a subject in the input image using a machine learning model, and estimates the position and posture of the subject by connecting joint points estimated to be joint points of the same subject. In the present exemplary embodiment, the joint points are set at the top of the head, neck, both elbows, both wrists, both knees, and both ankles, but the present disclosure is not limited to these.

Similarly, in the above-described personal recognition, posture estimation, and other evaluations using neural networks, an increase in the processing time along with an increase in the number of subjects may need to be addressed. As in the present exemplary embodiment, performing a screening of subjects in advance is effective in reducing the processing time.

The main subject determination unit 216 receives the detection result from the detection result output unit 214 and receives the evaluation result from the evaluation unit 215, and determines (decides) the main subject based on these results.

The tracking calculation unit 203 calculates an AF area and an AE area in a live view (LV) image (corresponding to the imaging surface of the imaging element 104) to track the main subject determined by the main subject determination unit 216. Specifically, the tracking calculation unit 203 determines the main subject or a surrounding area of the main subject including the main subject as a target area for AF and AE.

The focus calculation unit 204 acquires focus information in the AF area (the contrast evaluation value of the LV image and the defocus amount of the imaging optical system). The control unit 201 transmits to the lens unit 120 a focus instruction to control the position of the focus lens 121 based on the focus information. The lens unit 120 drives the focus lens 121 in response to the focus instruction. Accordingly, tracking AF is performed as focus control on the main subject.

The exposure calculation unit 205 acquires luminance information in the AE area. The control unit 201 transmits to the lens unit 120 an aperture instruction to control the opening amount of the aperture 122 based on the luminance information. The lens unit 120 drives the aperture 122 in response to the aperture instruction. Accordingly, tracking AE is performed as exposure control on the main subject.

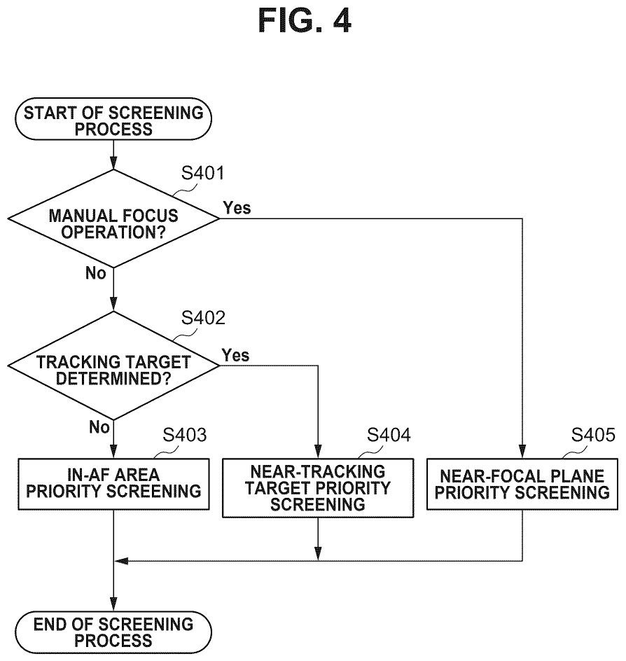

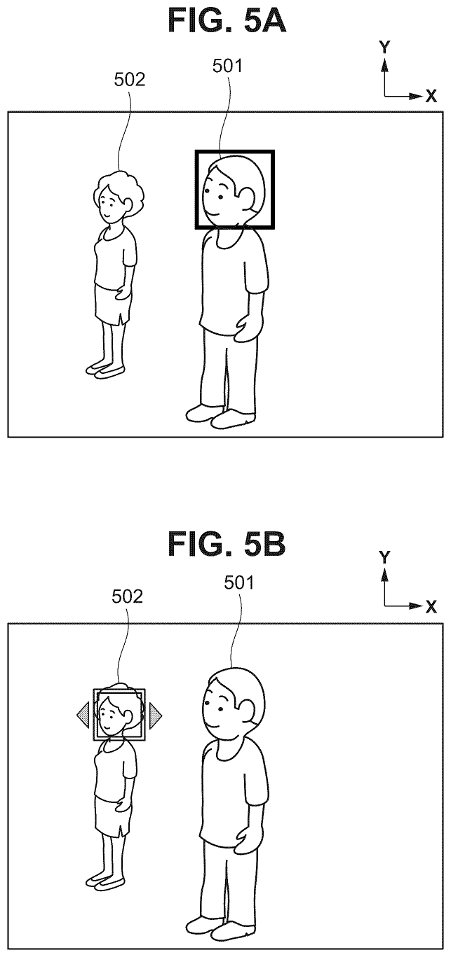

Next, the screening method used by the screening unit 212 will be described with reference to FIGS. 4 to 8B. FIG. 4 is a flowchart illustrating a process of selecting one of a plurality of screening methods, and FIGS. 5A to 8B are diagrams illustrating the screens displayed on the display unit 105 in response to operations in processing steps.

In step S401, the control unit 201 determines whether the user is manually controlling the focus state. More specifically, the control unit 201 determines whether the focus ring arranged in an annular shape around the optical axis of the lens unit 120 is being operated or whether a button on the lens unit 120 is being operated, a button on the camera body 101 is being operated or a menu operation is being performed via the display unit 105. If the focus control setting is set to manual focus, the control unit 201 determines that the focus is being manually operated. If the focus is being manually operated (YES in step S401), the process proceeds to step S405, and if not (NO in step S401), the process proceeds to step S402.

In step S402, the control unit 201 refers to the determination state of the main subject and determines whether the main subject has been determined as a tracking target. If the main subject has been determined as a tracking target (YES in step S402), the process proceeds to step S404, and if not (NO in step S402), the process proceeds to step S403.

The state in which the main subject has been determined as a tracking target here is a state in which the main subject has been set so as not to be changed even if another subject with a more favorable evaluation value that is to be determined as the main subject is detected. Operations for determining a subject as a tracking target include half-pressing the release button and touching the subject displayed on the display unit 105. When any of these operations is performed, the selected subject is determined as the tracking target, and the main subject determination unit 216 continues to select the determined subject as the main subject until the determination is cleared (by release of the half-pressed button, touch on a different subject, a lapse of a predetermined time, or the like).

FIGS. 5A and 5B are diagrams for illustrating a specific example of determining a tracking target. As illustrated in FIG. 5A, a plurality of subjects is seen in an input image. If no subject has been determined as the tracking target, the main subject determination unit 216 in the arithmetic device 102 selects the main subject based on the coordinates and the sizes of the subjects in the image. Normally, a subject 501 that is closer to the center of the image and is larger in size (present on the nearer side) may be determined as the main subject with a higher priority, and a frame is displayed around a part of the main subject.

The types of subjects are prioritized in advance, such as animals over vehicles and persons over animals. According to the priorities, a subject of the type with a higher priority is highly evaluated and is likely to be selected as the main subject. If the other person 502 that is not the main subject is touched, the main subject is switched to the person 502 as illustrated in FIG. 5B. While the person 501 is more suitable as the main subject in terms of coordinates and size, the person 502 is tracked as the main subject from then on. This state refers to the state in which the subject is determined as the tracking target. The design of the frame attached to the subject as the tracking target displayed on the display unit 105 is desirably changed so that it is easy to identify that the subject is determined as the tracking target. In the present exemplary embodiment, a subject that is not determined as the tracking target is represented with a single frame, and a determined subject is represented with a double frame.

Even after the tracking target is determined, it is possible to change the tracking target in response to a user operation. For example, specifying any of upward, downward, leftward, and rightward directions using the direction indication member of the operation unit 106 makes it possible to move the tracking target to another adjacent subject detected in that direction, and change the main subject sequentially in that direction. In the present exemplary embodiment, the main subject can be changed in the horizontal direction (X-axis direction).

The control unit 201 selects one of the screening methods in steps S403 to S405 based on the state determinations in steps S401 and S402, and executes screening.

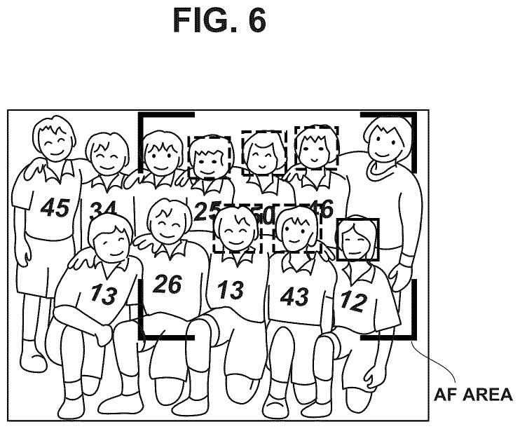

Next, each screening method will be described with reference to FIGS. 6 to 8B. The upper limit of the number of subjects that can be left after screening is set to six, and each of the left subjects is displayed with a dashed-line frame. The dashed-line frames are not necessarily displayed on the display unit 105, but are used for explanation purposes. Among the left subjects, the subject particularly selected as the main subject is displayed with a solid-line frame.

FIG. 6 is a diagram for describing in-AF area priority screening as the second screening method in step S403, and illustrates how the image obtained from the imaging element 104 is displayed on the display unit 105 during imaging. As described above, the dashed-line frames do not necessarily have to be displayed. The user sets the AF area as a detection area in advance. The AF area refers to an area that is searched for and determined as being most suitable for focusing and performing focus detection therein. The AF area can be selected as the entire image area or can be specified as a smaller area. In addition, the AF area can be set to any size and any position according to the user's imaging environment.

When the in-AF area priority screening is selected, the screening unit 212 selects the subjects detected in the AF area that is the candidate area, as candidates for the main subject. If there are subjects in the AF area that exceed the upper limit (a predetermined number), the screening unit 212 detects subjects closer to the center of the AF area with higher priority. Then, the screening unit 212 performs the above-described personal recognition, posture estimation, and other evaluations on each of the detected subjects, and sets the subject (for example, a person registered in advance) that has been determined to be suitable as the main subject as a result of the evaluation, as the main subject.

In this manner, screening the subjects in and around the AF area, which is the user's area of interest, makes it possible to select a subject that is desirable for the user as the main subject when the tracking target has not been determined and the user wishes to evaluate the detected subjects and select a suitable main subject.

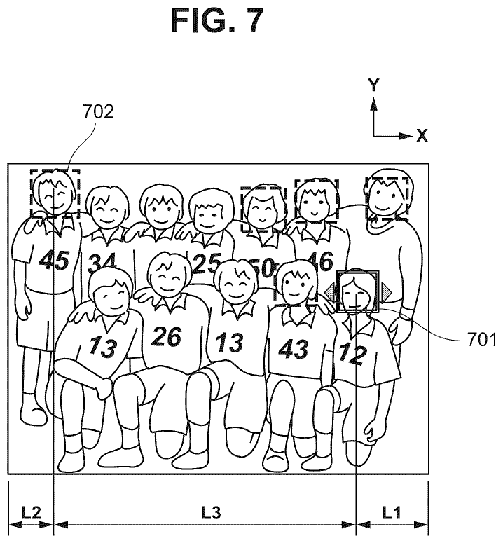

FIG. 7 is a diagram for describing the near-tracking target priority screening as the first screening method in step S404. The screening unit 212 performs the near-tracking target priority screening when the imaging setting is made to perform tracking processing, and tracking has been performed up to the previous frame, or a subject area has been specified by a user operation such as a touch operation. In the near-tracking target priority screening, the screening unit 212 calculates the distances between a tracking target 701 and other subjects, sets an area where the distances are within a predetermined distance range from the main subject as a candidate area, and selects subjects existing in the candidate area as candidates for the main subject. Each distance is calculated using the Euclidean distance based on the XY coordinates or the length of a vector obtained by orthogonally projecting a vector connecting two subjects onto the X axis or Y axis. In the present exemplary embodiment, since the main subject can be switched to a subject existing to the left or right of the current main subject, the distance is calculated using the length of the vector orthogonally projected onto the X axis. At the time of distance calculation, the distances are calculated in both the leftward and rightward directions with reference to the tracking target 701, and the smaller one is adopted. Taking a subject 702 as an example, the distance between the tracking target 701 and the subject 702 can be expressed as L3 or L1+L2, and the shorter distance L1+L2 is set as the distance to the subject 702. Accordingly, when a subject at an end of the image is the tracking target, a subject at the opposite end is detected. This makes it possible to switch the tracking target from the subject at one end of the image to the subject at the other end. In addition, since the subject next to the tracking target is always detected, the user can select all detectable subjects as the main subject by repeating subject switching in one direction.

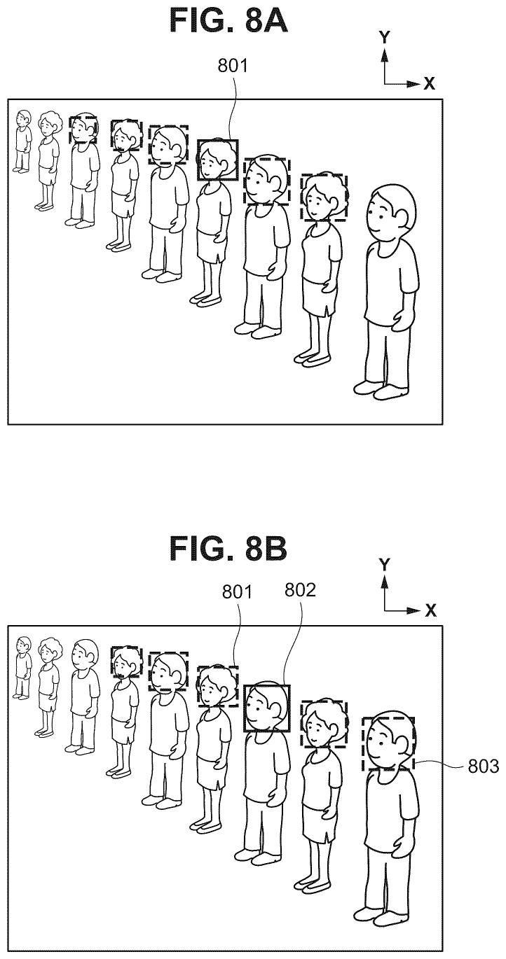

FIGS. 8A and 8B are diagrams for illustrating near-focal plane priority screening as the third screening method in step S405. The screening unit 212 performs the near-focal plane priority screening when the imaging setting is made to enable the user to manually adjust the focus. FIG. 8A illustrates an initial state in which a subject 801 is the main subject and the focus is adjusted to the subject 801. That is, the subject 801 is in focus, and a plane with the same depth as this subject is the focal plane. In perform screening, the defocus amount of the imaging optical system as depth information is referred to, and an area where the defocus amount is smaller than a predetermined value is set as a candidate area, and subjects existing in the candidate area are selected as candidates for the main subject. FIG. 8B illustrates a main subject detection result in the case where the user has manually operated the focus by using the focus ring or the operation unit 106 to shift the focal plane to the nearer side. The main subject is switched from the subject 801 to a subject 802, and the screening result is also changed such that the subject 803 is selected.

In this manner, for example, preferentially adopting a subject that is closer to the focal plane and setting it as the main subject makes it possible to implement an auxiliary function of adjusting the focal position to the main subject.

The near-focal plane priority screening can be used in combination with other screening methods. For example, when the in-AF area priority screening is selected, screening may be performed so as not to detect subjects that are extremely far from the focal plane.

As described above, in the present exemplary embodiment, in the subject detection system, at least one of a plurality of screening methods is selected based on the camera states, such as the subject tracking state and the user's focus operation state, and subjects are detected with an upper limit of a predetermined number. This makes it possible to select a subject that matches the user's intention as the main subject while suppressing the processing time even when additional evaluation is performed on the detected subjects, particularly when the processing load of the evaluation is high.

### Other Exemplary Embodiments

Aspects of the present disclosure can also be achieved as described below. That is, a storage medium on which a software program code for executing procedures for implementing the functions of each of the above-described exemplary embodiments is recorded is supplied to a system or apparatus, and a computer (or a CPU, MPU, or the like) of the system or apparatus reads out the program code from the storage medium and executes the same.

In this case, the program code read out from the storage medium implements the novel functions of the present disclosure, and the storage medium storing the program code and the program are embodiments of the present disclosure.

Examples of the storage medium for supplying the program code include a flexible disk, a hard disk, an optical disk, a magneto-optical disk, and the like. In addition, a compact disk read only memory (CD-ROM), a CD recordable (CD-R), a CD-rewritable (CD-RW), a digital versatile disc-ROM (DVD-ROM), a DVD-RAM, a DVD-RW, a DVD-R, a magnetic tape, a non-volatile memory card, a ROM, or the like may also be used.

The functions of the above-described exemplary embodiments are implemented by making executable the program code read out by the computer. The functions of the above-described exemplary embodiments are also implemented by the processing performed by an operating system (OS) or the like running on the computer and performing some or all of the actual processes based on the instructions from the program code.

The following cases are also aspects of the present disclosure. First, a program code is read from a storage medium and written into a memory included in a function expansion board inserted into a computer or a function expansion unit connected to the computer. Then, a CPU or the like, based on the instructions from the program code, in the function expansion board or function expansion unit performs some or all of the actual processes.

The disclosure of the present exemplary embodiment includes the following configurations and methods.

### (Configuration 1)

An image processing apparatus including:
a detection unit configured to detect a plurality of subjects from a captured image;
an area determination unit configured to determine a candidate area for determining a main subject from the captured image; and
a main subject determination unit configured to determine the main subject from among the plurality of subjects detected by the detection unit within the candidate area determined by the area determination unit,
wherein the area determination unit determines the candidate area based on a method associated with an imaging setting for capturing the captured image.

### (Configuration 2)

The image processing apparatus according to configuration 1, further including

a tracking unit configured to track the main subject determined by the main subject determination unit,
wherein in a case where the imaging setting is a setting for tracking the main subject determined by the main subject determination unit, the area determination unit determines an area within a predetermined distance range from the main subject as the candidate area.

### (Configuration 3)

The image processing apparatus according to configuration 1 or 2, further including a switching unit configured to sequentially switch the main subject to an adjacent subject in a predetermined direction from among the subjects detected by the detection unit in response to a user operation of an instruction to move in the predetermined direction.

### (Configuration 4)

The image processing apparatus according to any one of configurations 1 to 3, wherein in a case where the instruction to move in the predetermined direction is provided by the user operation and there is no other subject in the predetermined direction, the switching unit switches the main subject to a subject at a shortest distance from an end of the image opposite to the predetermined direction.

### (Configuration 5)

The image processing apparatus according to any one of configurations 1 to 4, wherein in a case where the end of the captured image is within a predetermined distance range from the main subject, the area determination unit determines as the candidate area an area within the predetermined distance range in combination with the distance from an end opposite to the end.

### (Configuration 6)

The image processing apparatus according to any one of configurations 1 to 5, wherein in a case where the imaging setting is a setting for autofocusing on a subject within an area specified by a user operation of specifying the area, the area determination unit sets the area specified by the user operation as the candidate area.

### (Configuration 7)

The image processing apparatus according to any one of configurations 1 to 6, wherein in a case where the imaging setting is a setting by which a focus position is manually changeable by a user operation, the area determination unit determines, as the candidate area, an area corresponding to a focal plane at a predetermined image plane distance from a focal plane of the main subject.

### (Configuration 8)

The image processing apparatus according to any one of configurations 1 to 7, wherein the main subject determination unit evaluates a plurality of subjects within the candidate area and determines a subject with a highest evaluation as the main subject.

### (Configuration 9)

The image processing apparatus according to configuration 8, wherein the main subject determination unit assigns a higher evaluation to a subject that is closer to a center of the captured image and is present on a nearer side, or is of a type with higher priority.

### (Configuration 10)

The image processing apparatus according to any one of configurations 1 to 7, further including an imaging unit configured to receive a light beam via an imaging optical system and output the captured image.

### (Configuration 11)

The image processing apparatus according to configuration 10, further including a tracking unit configured to track the main subject determined by the main subject determination unit in a plurality of captured images.

### (Method 1)

A control method of an image processing apparatus, the control method including:
detecting a plurality of subjects from a captured image;
determining a candidate area for determining a main subject from the captured image; and
determining the main subject from among the subjects detected by the detecting within the candidate area determined by the determining the area,
wherein the determining the area includes determining the candidate area based on a method associated with an imaging setting for capturing the captured image.

### (Configuration 12)

A computer-executable program executing a procedure for the control method of an image processing apparatus according to method 1.

### (Configuration 13)

A computer-readable storage medium storing a program for causing a computer to execute the control method of an image processing apparatus according to method 1.

According to the present disclosure, it is possible to determine a main subject that meets the user's intention from among a large number of subjects while achieving an increase in processing speed or a reduction in power consumption.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-052293, filed Mar. 27, 2024, which is hereby incorporated by reference herein in its entirety.

What is claimed is:

1. An image processing apparatus comprising:
one or more processors; and
at least one memory, in communication with the one or more processors, storing a program, which when executed by the one or more processors, cause the image processing apparatus to:
detect a plurality of subjects from a captured image;
determine a candidate area for determining a main subject from the captured image; and
determine the main subject from among the detected plurality of subjects within the determined candidate area,
wherein the determination of the candidate area is based on a method associated with an imaging setting for capturing the captured image.

2. The image processing apparatus according to claim 1,
wherein the program further causes the image processing apparatus to track the determined main subject,
wherein in a case where the imaging setting is a setting for tracking the determined main subject, the program causes the image processing apparatus to determine an area within a predetermined distance range from the main subject as the candidate area.

3. The image processing apparatus according to claim 2, wherein the program causes the image processing apparatus to sequentially switch the main subject to an adjacent subject in a predetermined direction from among the detected subjects in response to a user operation of an instruction to move in the predetermined direction.

4. The image processing apparatus according to claim 3, wherein in a case where the instruction to move in the predetermined direction is provided by the user operation and there is no other subject in the predetermined direction, the program causes the image processing apparatus to switch the main subject to a subject at a shortest distance from an end of the image opposite to the predetermined direction.

5. The image processing apparatus according to claim 4, wherein in a case where the end of the captured image is within a predetermined distance range from the main subject, the program causes the image processing apparatus to determine as the candidate area an area within the predetermined distance range in combination with the distance from an end opposite to the end.

6. The image processing apparatus according to claim 1, wherein in a case where the imaging setting is a setting for autofocusing on a subject within an area specified by a user operation of specifying the area, the program causes the image processing apparatus to set the area specified by the user operation as the candidate area.

7. The image processing apparatus according to claim 1, wherein in a case where the imaging setting is a setting by which a focus position is manually changeable by a user operation, the program causes the image processing apparatus to determine, as the candidate area, an area corresponding to a focal plane at a predetermined image plane distance from a focal plane of the main subject.

8. The image processing apparatus according to claim 1, wherein the program causes the image processing apparatus to evaluate a plurality of subjects within the candidate area and to determine a subject with a highest evaluation as the main subject.

9. The image processing apparatus according to claim 8, wherein the program causes the image processing apparatus to assign a higher evaluation to a subject that is closer to a center of the captured image and is present on a nearer side, or is of a type with higher priority.

10. The image processing apparatus according to claim 1, wherein the program causes the image processing apparatus to receive a light beam via an imaging optical system and output the captured image.

11. The image processing apparatus according to claim 10, wherein the program causes the image processing apparatus to track the determined main subject in a plurality of captured images.

12. A control method of an image processing apparatus, the control method comprising:
detecting a plurality of subjects from a captured image;
determining a candidate area for determining a main subject from the captured image; and
determining the main subject from among the detected plurality of subjects within the determined candidate area,
wherein determining the candidate area is based on a method associated with an imaging setting for capturing the captured image.

13. A non-transitory computer-readable storage medium storing a program for causing a computer to execute a control method, the control method comprising:
detecting a plurality of subjects from a captured image;
determining a candidate area for determining a main subject from the captured image; and
determining the main subject from among the detected plurality of subjects within the determined candidate area.,
wherein determining the candidate area is based on a method associated with an imaging setting for capturing the captured image.
